(19) United States
(12) Patent Application Publication
(10) Pub. No.: US 2024/0002574 A1
(43) Pub. Date: Jan. 4, 2024

(54) A THERMOPLASTIC POLYURETHANE RESIN COMPOSITION

(71) Applicant: Huntsman International LLC, The Woodlands, TX (US)

(72) Inventors: Zarif Farhana Mohd ARIS, Dracut, MA (US); Lidina Kalunga CANUTO, Lowell, MA (US); Christopher Charles MARKEN, Williams Bay, WI (US); Lan CAO, Arlington, MA (US)

(21) Appl. No.: 18/039,426

(22) PCT Filed: Dec. 1, 2021
(86) PCT No.: PCT/US2021/061339

§ 371 Date: May 30, 2023

Related U.S. Application Data
(60) Provisional application No. 63/120,450, filed on Dec. 2, 2020.

(51) Int. Cl. C08G 18/12; C08K 5/3492; C08K 5/3475; C08K 5/3435; C08G 18/32; C08G 18/42; C08J 5/18; C08L 75/06

(52) U.S. Cl. CPC C08G 18/12; C08K 5/3492; C08K 5/3475; C08K 5/3435; C08G 18/3206; C08G 18/4277; C08J 5/18; C08L 75/06; C08L 2201/08; C08L 2203/16; C08K 2201/014

(57) ABSTRACT

A thermoplastic polyurethane resin composition comprising: a thermoplastic polyurethane resin; an ultraviolet absorber package comprising a benzotriazole compound (UVA1), and a triazine compound (UVA2) wherein the mass ratio of UVA1 to UVA2 is from 1:1 to 3:1; optionally, a hindered amine light stabilizer and/or an antioxidant compound; and wherein the thermoplastic polyurethane resin composition has a maximum ultraviolet transmittance of ≤3% in the wavelengths between 280 nm and 365 nm and an ultraviolet transmittance of ≤6% in the wavelengths between 365 nm and 370 nm when the thermoplastic polyurethane resin is formed into a film having a thickness of 6 mils and wherein the cumulative weight % of UVA1 and UVA2 in the polyurethane resin composition ranges from 0.5 wt % to 0.85 wt % based on the total weight of the polyurethane resin composition.

### BACKGROUND

### Field

The present disclosure relates generally to a thermoplastic polyurethane resin composition having certain accelerated weathering resistance and ultraviolet transmission properties.

### Background

Thermoplastic polyurethane (“TPU”) resins are often used in variety of end use applications requiring strength, flexibility, and abrasion resistance. For instance, TPU resins are used to protect substrates, such as coated substrates, from physical damage as well as damage caused by the ultraviolet rays of sunlight. That is why TPU based films are often used in the automotive industry to protect various parts of an automotive vehicle from debris (e.g., rocks or stones) that might impact the vehicle during operation. In addition to providing physical protection against debris, TPU based films are also used to protect the paint underneath the film from the damaging effects of ultraviolet light which can often cause paint to dull over time or delaminate from the vehicle.

Despite TPU resins having physical properties that are desirable for use in the automotive industry, there still is a need to improve such resins to attain better performance.

### DETAILED DESCRIPTION

As used herein, unless otherwise expressly specified, all numbers such as those expressing values, ranges, amounts or percentages may be read as if prefaced by the word “about”, even if the term does not expressly appear. Plural encompasses singular and vice versa.

As used herein, “plurality” means two or more while the term “number” means one or an integer greater than one.

As used herein, “includes” and like terms means “including without limitation.”

When referring to any numerical range of values, such ranges are understood to include each and every number and/or fraction between the stated range minimum and maximum. For example, a range of “1 to 10” is intended to include all sub-ranges between (and including) the recited minimum value of 1 and the recited maximum value of 10.

Unless otherwise stated herein, “molecular weight” means weight average molecular weight (M_{w}) as determined by Gel Permeation Chromatography.

Unless otherwise stated herein, reference to any compounds shall also include any isomers (e.g., stereoisomers) of such compounds.

Unless otherwise stated herein, reference to any compounds shall also include any isomers (e.g., stereoisomers) of such compounds.

### Thermoplastic Polyurethane Resin Composition

The thermoplastic polyurethane resin composition of the present disclosure is comprised of: (i) a thermoplastic polyurethane resin; (ii) an ultraviolet absorber package comprising a benzotriazole compound (UVA1) and a triazine compound (UVA2) wherein the mass ratio of UVA1 to UVA2 is from 1:1 to 3:1; and, optionally, (iii) a hindered amine light stabilizer and/or an antioxidant compound; and wherein the thermoplastic polyurethane resin composition has a maximum ultraviolet transmittance of ≤3% in the wavelengths between 280 nm and 365 nm and an ultraviolet transmittance of ≤6% in the wavelengths between 365 nm and 370 nm when the thermoplastic polyurethane resin composition is formed into a film having a thickness of 6 mils and wherein the cumulative weight % of UVA1 and UVA2 in the polyurethane resin composition ranges from 0.5 wt % to 0.85 wt % based on the total weight of the polyurethane resin composition.

In certain embodiments, the thermoplastic polyurethane resin composition further comprises an oxanilide compound (UVA3) as described in further detail below.

### Component (i): Thermoplastic Polyurethane Resin

The thermoplastic polyurethane resin composition comprises a thermoplastic polyurethane resin that is the reaction product of: (a) an isocyanate compound, (b) an isocyanate reactive compound, and (c) a chain extender. One benefit of the thermoplastic polyurethane resin composition disclosed herein is that it exhibits desired ultraviolet transmittance and weather performance while using a minimal load of ultraviolet stabilizer compounds.

Component (i) can comprise 95% to 99% by weight based on the total weight of the thermoplastic polyurethane resin composition.

### Isocyanate Compound

Suitable isocyanate compounds that may be used as Component (a) include aliphatic, araliphatic, and/or aromatic polyisocyanates. The isocyanate compounds typically have the structure R—(NCO)ₓ where x is at least 2 and R comprises an aromatic, aliphatic, or combined aromatic/aliphatic group. Non-limiting examples of suitable polyisocyanates include diphenylmethane diisocyanate (“MDI”) type isocyanates (e.g., 2,4′, 2,2′, 4,4′MDI or mixtures thereof), mixtures of MDI and oligomers thereof (e.g., polymeric MDI or “crude” MDI), and the reaction products of polyisocyanates with components containing isocyanate-reactive hydrogen atoms (e.g., polymeric polyisocyanates or prepolymers). Accordingly, SUPRASEC® DNR isocyanate, SUPRASEC® 2185 isocyanate, RUBINATE® M isocyanate, and RUBINATE® 1840 isocyanate, or combinations thereof may be used as the isocyanate compound. SUPRASEC® and RUBINATE® isocyanate compounds are available from Huntsman International LLC.

Other examples of suitable isocyanate compounds include tolylene diisocyanate (“TDI”) (e.g., 2,4 TDI, 2,6 TDI, or combinations thereof), hexamethylene diisocyanate (“HMDI” or “HDI”), isophorone diisocyanate (“IPDI”), butylene diisocyanate, trimethylhexamethylene diisocyanate, di(isocyanatocyclohexyl)methane (e.g., 4,4′-diisocyanatodicyclohexylmethane), isocyanatomethyl-1,8-octane diisocyanate, tetramethylxylene diisocyanate (“TMXDI”), 1,5-naphtalenediisocyanate (“NDI”), p-phenylenediisocyanate (“PPDI”), 1,4-cyclohexanediisocyanate (“CDI”), tolidine diisocyanate (“TODI”), or combinations thereof. Modified polyisocyanates containing isocyanurate, carbodiimide, or uretonimine groups may also be employed as Component (a).

Blocked polyisocyanates can also be used as Component (a) provided that the reaction product has a deblocking temperature below the temperature at which Component (a) will be reacted with Component (b). Suitable blocked polyisocyanates can include the reaction product of: (x) a phenol or an oxime compound and a polyisocyanate, or (y) a polyisocyanate with an acid compound such as benzyl chloride, hydrochloric acid, thionyl chloride or combinations.

Mixtures of isocyanates, such as a mixture of TDI isomers (e.g., mixtures of 2,4- and 2,6-TDI isomers) or mixtures of di- and higher polyisocyanates produced by phosgenation of aniline/formaldehyde condensates, may also be used as Component (a).

In some embodiments, the isocyanate compound is liquid at room temperature. A mixture of isocyanate compounds may be produced in accordance with any technique known in the art. The isomer content of the diphenyl-methane diisocyanate may be brought within the required ranges, if necessary, by techniques that are well known in the art. For example, one technique for changing isomer content is to add monomeric MDI (e.g., 2,4-MDI) to a mixture of MDI containing an amount of polymeric MDI (e.g., MDI comprising 30% to 80% w/w 4,4′-MDI and the remainder of the MDI comprising MDI oligomers and MDI homologues) that is higher than desired.

Component (a) can comprise 25% to 75% % (e.g., 40% of the aliphatic polyfunctional isocyanate compound) by weight based on the total weight of the composition used to form the thermoplastic polyurethane resin.

### Isocyanate Reactive Compound

Suitable isocyanate reactive compounds that may be used as Component (b) include organic compounds containing at least two isocyanate reactive moieties per molecule. The isocyanate reactive compounds are typically liquid at 25° C., have a molecular weight ranging from 60 to 10,000 (e.g., 300 to 10,000 or less than 5,000), a nominal hydroxyl functionality of at least 2, and a hydroxyl equivalent weight of 30 to 2000 (e.g., 30 to 1,500 or 30 to 800).

Examples of suitable polyols that may be used as Component (b) include polyether polyols, such as those made by addition of alkylene oxides to initiators, which containing from 2 to 8 active hydrogen atoms per molecule. Suitable alkylene oxides that may be used to form the polyether polyols include ethylene oxide, propylene oxide, and butylene oxide, or combinations thereof. Suitable initiators that may be used include glycols, glycerol, trimethylolpropane, triethanolamine, pentaerythritol, sorbitol, sucrose, ethylenediamine, ethanolamine, diethanolamine, aniline, toluenediamines (e.g., 2,4 and 2,6 toluenediamines), polymethylene polyphenylene polyamines, N-alkylphenylene-diamines, o-chloro-aniline, p-aminoaniline, diaminonaphthalene, or combinations thereof.

Other suitable polyol compounds that may be used as Component (b) include Mannich polyols that have a nominal hydroxyl functionality of at least 2 and at least one secondary or tertiary amine nitrogen atom per molecule. In some embodiments, Mannich polyols are the condensates of an aromatic compound, an aldehyde, and an alkanol amine. For example, a Mannich condensate may be produced by the condensation of (i) a phenol and/or an alkylphenol with (ii) a formaldehyde, monoethanolamine, diethanolamine, and/or diisopronolamine. In some embodiments, the Mannich condensates are the reaction products of phenol or nonylphenol with formaldehyde and diethanolamine. In some embodiments, the Mannich condensates serve as initiators for alkoxylation. An alkylene oxide (e.g., those alkylene oxides mentioned above) may be used for alkoxylating one or more Mannich condensates. When polymerization is complete, the Mannich polyol comprises primary hydroxyl groups and/or secondary hydroxyl groups bound to aliphatic carbon atoms.

Other suitable polyols that may be used are polyether polyols that comprise propylene oxide (“PO”), ethylene oxide (“EO”), or a combination of PO and EO groups or moieties in the polymeric structure of the polyols. These PO and EO units may be arranged randomly or in block sections throughout the polymeric structure. In certain embodiments, the EO content of the polyol ranges from 0 to 100% by weight based on the total weight of the polyol (e.g., 50% to 100% by weight). In some embodiments, the PO content of the polyol ranges from 100 to 0% by weight based on the total weight of the polyol (e.g., 100% to 50% by weight). In yet other embodiments, the EO content of a polyol can range from 99% to 33% by weight of the polyol while the PO content ranges from 1% to 66% by weight of the polyol. In certain embodiments, the EO and/or PO units can either be located terminally on the polymeric structure of the polyol or within the interior sections of the polymeric backbone structure of the polyol. Suitable polyether polyols include poly(oxyethylene oxypropylene) diols and triols obtained by the sequential addition of propylene and ethylene oxides to di- or trifunctional initiators. In some embodiments, the polyether polyols used in the present disclosure include the reaction products obtained by the polymerization of ethylene oxide with another cyclic oxide (e.g., propylene oxide) in the presence of a polyfunctional initiator (e.g., such as water and low molecular weight polyols). Low molecular weight polyols that may be used include ethylene glycol, propylene glycol, diethylene glycol, dipropylene glycol, cyclohexane dimethanol, resorcinol, bisphenol A, glycerol, trimethylolopropane, 1,2,6-hexantriol, pentaerythritol, or combinations thereof. In certain embodiments, Component (b) comprises the diols or triols mentioned above or a combination thereof.

Polyester polyols that can be used as Component (b) include polyester polyols having a linear polymeric structure and a number average molecular weight (Mn) ranging from about 500 to about 10,000 (e.g., preferably from about 700 to about 5,000 or 700 to about 4,000) and an acid number generally less than 1.3 (e.g., less than 0.8). The molecular weight is determined by assay of the terminal functional groups and is related to the number average molecular weight. The polyester polyols can be produced by: (1) an esterification reaction of one or more glycols with one or more dicarboxylic acids or anhydrides; or (2) a transesterification reaction (i.e. the reaction of one or more glycols with esters of dicarboxylic acids). Mole ratios generally in excess of more than one mole of glycol to acid are preferred to obtain linear polymeric chains having terminal hydroxyl groups. The polyester polyols also include various lactones that are typically made from caprolactone and a bifunctional initiator such as diethylene glycol. The dicarboxylic acids of the desired polyester polyol can be aliphatic, cycloaliphatic, aromatic, or combinations thereof. Suitable dicarboxylic acids have a total of from 4 to 15 carbon atoms include succinic, glutaric, adipic, pimelic, suberic, azelaic, sebacic, dodecanedioic, isophthalic, terephthalic, cyclohexane dicarboxylic, or combinations thereof. Anhydrides of the aforementioned dicarboxylic acids (e.g., phthalic anhydride, tetrahydrophthalic anhydride, or combinations thereof) can also be used. In some embodiments, adipic acid is the preferred acid. The glycols used to form suitable polyester polyols can include aliphatic and aromatic glycols having a total of from 2 to 12 carbon atoms. Examples of such glycols include ethylene glycol, 1,2-propanediol, 1,3-propanediol, 1,3-butanediol, 1,4-butanediol, 1,5-pentanediol, 1,6-hexanediol, 2,2-dimethyl-1,3-propanediol, 1,4-cyclohexanedimethanol, decamethylene glycol, dodecamethylene glycol, or combinations thereof.

Additional examples of suitable polyols that may be used as Component (b) include hydroxyl-terminated polythioethers, polyamides, polyesteramides, polycarbonates, polyacetals, polyolefins, polysiloxanes, and simple glycols such as ethylene glycol, butanediols, diethylene glycol, triethylene glycol, the propylene glycols, dipropylene glycol, tripropylene glycol, or combinations thereof.

Component (b) may also contain other isocyanate reactive compounds including polyamines and polythiols. Suitable polyamines include primary and secondary amine-terminated polyethers, aromatic diamines (e.g., diethyltoluene diamine, aromatic polyamines), or combinations thereof.

Component (b) can comprise 25% to 75% (e.g., 50% Polycaprolactone polyol) by weight based on the total weight of the composition used to form the thermoplastic polyurethane resin.

### Chain Extender

Suitable compounds that may be used as Component (c) include low molecular weight diols and bifunctional low molecular weight glycol ethers. Examples of suitable law molecular weight diols include ethylene glycol, 1,2-propanediol, 1,3-propanediol, 1,2-butanediol, 1,3-butanediol, 1,4-butanediol, 1,5-pentanediol, 1,6-hexanediol, diethylene glycol, dipropylene glycol, neopentyl glycol, 3-methyl-1,5-pentanediol, 2,2-diethyl-1,3-propanediol, 2-n-butyl-2-ethyl-1,3-propanediol, 2,2,4-trimethyl-1,3-pentanediol, 2-ethyl-1,3-hexanediol, 1,4-cyclohexane dimethanol, 1,4-bis(2-hydroxyethoxy)benzene, or combinations thereof.

Component (c) can comprise 2% to 15% (e.g., 10% 1,4-Butanediol) by weight based on the total weight of the composition used to form the thermoplastic polyurethane resin.

### Component (ii): Ultraviolet Absorber Package

The thermoplastic polyurethane resin composition also contains an ultraviolet absorber package that comprises a benzotriazole compound (“UVA1”) and a triazine compound (“UVA2”). In certain embodiments, the mass ratio of UVA1 to UVA2 is from 1:1 to 3:1.

Suitable benzotriazole compounds that may be used in the thermoplastic polyurethane resin composition include 2-(2H-benzotriazol-2-yl)-6-(1-methyl-1-phenylethyl)-4-(1,1,3,3-tetramethylbutyl) phenol, 2-phenol, 2-(2H-benzotriazol-2-yl)-4-(1,1,3,3-tetramethylbutyl), or combinations thereof. In some embodiments, UVA1 may have a maximum melting point temperature of 141° C.

Suitable triazine compounds that may be used in the thermoplastic polyurethane resin composition include hydroxyphenyl-triazine, 2-[4,6-bis(2,4-dimethylphenyl)-1,3,5-triazin-2-yl]-5-[3-[(2-ethylhexyl)oxy]-2-hydroxypropoxyl], or combinations thereof. In some embodiments, UVA2 may have a maximum melting point temperature of 148° C.

The ultraviolet absorber package may further comprise an oxanilide compound (“UVA3”). When present, the mass ratio of UVA1 to UVA2 to UVA3 is from 1:1:0.2 to 3:1:1. In some embodiments, UVA3 may have a maximum melting point temperature of 127° C.

Component (ii) can comprise 0.05% to 0.85% (e.g., 0.25% UVA1 and 0.25% UVA2) by weight based on the total weight of the thermoplastic polyurethane composition. While Component (ii) can be present in an amount ranging from 0.05% to 0.85% by weight, it should be noted that the actual amounts of UVA1 and UVA2 can vary. For example, in some embodiments, UVA1 can be present in an amount of 0.25% by weight while UVA2 is also present in an amount of 0.25% by weight. However, in other embodiments, UVA1 can be present in an amount of 0.5% while UVA2 is present in an amount of 0.2% by weight. Accordingly, a formulator can modify the amounts of UVA1 and UVA2 to achieve desired or targeted properties.

### Component (iii): Other Additives

The thermoplastic polyurethane resin composition can, optionally, contain a other additives such as a hindered amine light stabilizer compound, an antioxidant compound, or combinations thereof.

Suitable hindered amine light stabilizer compound that may be used in the thermoplastic polyurethane resin composition include additives from the TINUVIN family of hindered amine light stabilizers available from BASF (including additives equivalent in structure available from other manufacturers).

Suitable antioxidant compounds that may be used in the thermoplastic polyurethane resin composition include additives from the IRGANOX, IRGAFOS family of antioxidant compounds available from BASF (including additives equivalent in structure available from other manufacturers), or combinations thereof.

When present, Component (iii) can comprise 0.1% to 1% (e.g., 0.25% Tinuvin 622) by weight based on the total weight of the thermoplastic polyurethane composition.

### Method of Making Thermoplastic Polyurethane Resin Composition

The thermoplastic polyurethane resin composition disclosed herein can be made by reacting a reactive mixture comprising an isocyanate compound, an isocyanate reactive compound, and a chain extender compound to form the thermoplastic polyurethane resin. The reactive mixture also comprises the ultraviolet absorber package comprising a benzotriazole compound (UVA1) and a traizine compound (UVA2) at a mass ratio of UVA1 to UVA2 is from 1:1 to 3:1. In certain embodiments, the ultraviolet absorber package can further comprise an oxanilide compound (“UVA3”). When present, the mass ratio of UVA1 to UVA2 to UVA3 is from 1:1:0.2 to 3:1:1. Optionally, the reactive mixture may also contain one or more additives such as a hindered amine light stabilizer compound, an antioxidant compound, or combinations thereof.

In certain embodiments, the components listed above can all be introduced into a reaction vessel simultaneously. In these embodiments, the thermoplastic polyurethane resin will form in situ in the presence of the other additives present in the reaction vessel. It is noted that these other additives, such as the ultraviolet absorbers mentioned above, will not be incorporated into the polymer structure of the thermoplastic polyurethane resin. Rather, these additives will simply be found in the matrix of the thermoplastic polyurethane resin composition.

In other embodiments, the reactive components used to form the thermoplastic polyurethane resin can first be added to the reaction vessel prior to introduction of the other additives described above. In some embodiments, the polyurethane resin can be partially formed prior to introduction of the additives.

### Properties of Thermoplastic Polyurethane Resin Composition

When formed into a film having a thickness of 6 mil (e.g., via extrusion of TPU pellets made using the disclosed thermoplastic polyurethane resin composition), the thermoplastic polyurethane resin composition has a maximum ultraviolet transmittance (“UVT”) of ≤3% (e.g., ≤2% or ≤1%) in the wavelengths between 280 nm and 365 nm and an ultraviolet transmittance of s 6% (e.g., ≤5.8%, ≤5.5%, or ≤5.5%) in the wavelengths between 365 nm and 370 nm. In certain embodiments, the thermoplastic polyurethane resin composition has a maximum UVT of ≤5% in the wavelengths between 200 nm and 315 nm and a maximum UVT of ≤3% in the wavelengths between 315 nm and 350 nm in addition to the UVT performance between 365 nm and 370 nm mentioned above. The maximum UVT can be measured using the UV-VIS SPEC TEST. As used herein, the UV-VIS SPEC TEST means: (1) providing a TPU film having a thickness of 6 mils and formed from a thermoplastic polyurethane resin composition, such as the one disclosed herein; and (2) using a Agilent Technologies Model Cary 300 UV/Visible light spectrometer to obtain the film's UVT at various wavelengths.

In addition to the UVT properties listed above, the thermoplastic polyurethane resin composition also exhibits excellent UV-A and UV-B weather durability when it is formed into a film having a thickness of 6 mils and subjected to UV-A and UV-B light pursuant to ASTM G154.

In certain embodiments, the thermoplastic polyurethane resin composition has a minimum tensile strength of 6500 psi as measured by ASTM D412 when it is formed into a film having a thickness of 6 mils.

### Paint Protection Film

The thermoplastic polyurethane resin composition of the present disclosure can be used in the manufacture a paint protection film where the TPU film derived from the thermoplastic polyurethane composition is sandwiched between a topcoat layer and an adhesive layer.

### Modifications

While specific embodiments of the disclosure have been described in detail, it will be appreciated by those skilled in the art that various modifications and alternatives to those details could be developed considering the overall teachings of the disclosure. Accordingly, the arrangements disclosed herein are meant to be illustrative only and not limiting as to the scope of the disclosure which is to be given the full breadth of the claims appended and all equivalents thereof. Therefore, any of the features and/or elements which are listed above may be combined with one another in any combination and still be within the breadth of this disclosure.

### Examples

### Components:

Aliphatic Isocyanate: H12MDI available from Covestro AG.

CAPA Polyol: Polycaprolactone available from Ingevity Corp.

Chain Extender: 1,4-butanediol having a molecular weight less than 200.

### Synthesis

The thermoplastic polyurethane resin compositions were synthesized through a batch process using Aliphatic Isocyanate, CAPA polyol, and the Chain Extender. The TPU composition contains UV stabilizer additives and other common additives, such as antioxidant (AO), processing stabilizer and hindered amine light stabilizers.

The CAPA Polyol, Chain Extender and additives (antioxidant (AO), processing stabilizer, UV absorbers and hindered amine light stabilizers are charged into a reaction vessel and mixed. The Aliphatic Isocyanate was then added under agitation. After the reaction mixture reached 90° C. to 100° C., it was poured into a Teflon lined mold and cured at room temperature for 2 days. After curing, the product was further chopped into granules and processed into pellets and extruded into 6 mil thick film for UV spectroscopy testing, accelerated weathering test (UVA and UVB aging), hydrolysis testing and physical property testing (e.g., tested via the UV-VIS SPEC TEST).

Ex. 1 through Ex. 2 shown in Table 1 were synthesized using UVA1 and UVA3 which gave poor UVT Profile (above 6% UV Transmission between 280-370 nm wavelength) at 6 mil thick films.

Ex. 3 through Ex. 5 shown in Table 2 were synthesized using a single UVA1 absorber which gave moderate UVT Profile (Below 4% UV Transmission between 280-370 nm wavelength) at 6 mil thick films.

Ex. 6 through Ex. 8 shown in Table 3 were synthesized using a mixed UV absorber (UVA 1 and UVA 2) at ratio 1:1 which gave moderate UVT Profile (Below 6% UV Transmission between 280-370 nm wavelength) at 6 mil thick films.

Ex. 9 through Ex. 10 shown in Table 4 were synthesized using a mixed UV absorber (UVA1 and UVA2) with Excellent UVT Profile Below 1% from 280-370 nm Wavelength at 6 mil thick films

Ex. 11 shown in Table 5 were synthesized using a mixed UV absorber (UVA1, UVA2 and UVA3) with Excellent UVT Profile Below 1% from 280-370 nm Wavelength at 6 mil thick films

As one can see, the selection of a specific type of UV absorber at a certain level and ratio will provide excellent UVT profile, good color film as well as overall good weathering performance suitable to be used as paint protection films.

TABLE 1
Examples of Formulation with Poor UVT Profile

| TPU composition | Example 1 | Example 2 |
|---|---|---|
| Aliphatic Isocyanate | 39.95 | 39.9 |
| CAPA Polyol | 48.56 | 48.38 |
| Chain Extender | 10.09 | 10.09 |
| Antioxidant | 0.7 | 0.7 |
| Processing Stabilizer | 0.15 | 0.15 |
| UV Absorber 1 | — | 0.25% |
| | | Tinuvin 928 |
| UV Absorber 2 | — | — |
| UV Absorber 3 | 0.5% | 0.25% |
| | Tinuvin 312 | Tinuvin 312 |
| Hindered Amine Light | 0.25% | 0.25% |
| Stabilizers | Tinuvin 622 | Tinuvin 622 |
| Total | 100 | 100 |
| UVT (6 mil film) | <50% | <11% |
| (280-365 nm) | | |
| UVT (6 mil film) | <60% | <11% |
| (365-370 nm) | | |
| Initial YI (6 mil film) | 0.73 | 0.77 |

TABLE 2
Example of Formulations Using Single UV Absorber

| TPU composition | Example 3 | Example 4 | Example 5 |
|---|---|---|---|
| Aliphatic Isocyanate | 39.95 | 39.95% | 40.0% |
| CAPA Polyol | 48.56 | 48.56% | 48.46% |
| Chain Extender | 10.09 | 10.09% | 10.07% |
| Antioxidant | 0.7 | 0.7% | 0.7% |
| Processing Stabilizer | 0.15 | 0.15% | 0.15% |
| UV Absorber 1 | 0.4% | 0.4% | 0.4% |
| | Tinuvin 928 | Tinuvin 329 | Tinuvin 234 |
| UV Absorber 2 | — | — | — |
| UV Absorber 3 | — | — | — |
| Hindered Amine Light | 0.13% | 0.13% | 0.13% |
| Stabilizers | Tinuvin 622 | Tinuvin 622 | Tinuvin 622 |
| Total | 100 | 100 | 100 |
| UVT (6 mil film) | <2% | <1% | <1% |
| (280-365 nm) | | | |
| UVT (6 mil film) | <4% | <3% | <1.9% |
| (365-370 nm) | | | |
| Initial YI (6 mil film) | 0.70 | 0.42 | 0.44 |

TABLE 3
Example of Formulations Using Mixed Absorber
(UVA1 and UVA2)

| TPU | | | |
|---|---|---|---|
| composition | Example 6 | Example 7 | Example 8 |
| Aliphatic | 39.9% | 39.9% | 39.9 |
| Isocyanate | | | |
| CAPA Polyol | 48.25% | 48.25% | 48.38 |
| Chain Extender | 10.09% | 10.02% | 10.09 |
| Antioxidant | 0.7% | 0.7% | 0.7 |
| Processing | 0.15% | 0.15% | 0.15 |
| Stabilizer | — | — | — |
| UV Absorber 1 | 0.35% | 0.35% | 0.25% |
| | Tinuvin 329 | Tinuvin 234 | Tinuvin 928 |
| UV Absorber 2 | 0.35% | 0.35% | 0.25% |
| | Tinuvin 405 | Tinuvin 405 | Tinuvin 405 |
| UV Absorber 3 | — | — | — |
| Hindered Amine | 0.25% | 0.25% | 0.25% |
| Light Stabilizers | Tinuvin 622 | Tinuvin 622 | Tinuvin 622 |
| Total | 100 | 100 | 100 |
| UVT (6 mil film) | <1% | <1% | <2.3% |
| (280-365 nm) | | | |
| UVT (6 mil film) | <3.8% | <1.5% | <5.75% |
| (365-370 nm) | | | |
| Initial YI (6 mil film) | 0.60 | 0.66 | 0.60 |

TABLE 4
Example of Formulations Using Mixed Absorber (UVA1 and UVA2)
with Excellent UVT Profile Below 1% from 280-370 nm
Wavelength

| TPU composition | Example 9 | Example 10 |
|---|---|---|
| Aliphatic | 39.9% | 40.0% |
| Isocyanate | | |
| CAPA Polyol | 48.38% | 48.35% |
| Chain Extender | 10.09% | 10.04% |
| Antioxidant | 0.7% | 0.7% |
| Processing | 0.15% | 0.15% |
| Stabilizer | | |
| UV Absorber 1 | 0.25% | 0.25% |
| | Tinuvin 928 | Tinuvin 329 |
| UV Absorber 2 | 0.25% | 0.25% |
| | Tinuvin 460 | Tinuvin 460 |
| UV Absorber 3 | — | — |
| Hindered Amine | 0.25% | 0.25% |
| Light Stabilizers | Tinuvin 622 | Tinuvin 622 |
| Total | 100 | 100 |
| UVT (6 mil film) | <1% | <1% |
| (280-365 nm) | | |
| UVT (6 mil film) | <1% | <1% |
| (365-370 nm) | | |
| Initial YI (6 mil film) | 0.88 | 0.79 |

TABLE 5
Example of Formulations Using Mixed Absorber (UVA1, UVA2 and
UVA3) with Excellent UVT Profile Below 1% from 280-370 nm
Wavelength

| TPU composition | Example 11 |
|---|---|
| Aliphatic Isocyanate | 39.9% |
| CAPA Polyol | 48.15% |
| Chain Extender | 10.06% |
| Antioxidant | 0.7% |
| Processing Stabilizer | 0.15% |
| UV Absorber 1 | 0.3% Tinuvin 329 |
| UV Absorber 2 | 0.3% Tinuvin 460 |
| UV Absorber 3 | 0.1% Tinuvin 312 |
| Hindered Amine Light Stabilizers | 0.25% Tinuvin 622 |
| Total | 100 |
| UVT (6 mil film) | <1% |
| (280-365 nm) | |
| UVT (6 mil film) | <1% |
| (365-370 nm) | |
| Initial YI (6 mil film) | 0.87 |

What is claimed is:

1. A thermoplastic polyurethane resin composition comprising:
a thermoplastic polyurethane resin;
an ultraviolet absorber package comprising a benzotriazole compound (UVA1), and a triazine compound (UVA2) wherein the mass ratio of UVA1 to UVA2 is from 1:1 to 3:1; optionally, a hindered amine light stabilizer and/or an antioxidant compound; and
wherein the thermoplastic polyurethane resin composition has a maximum ultraviolet transmittance of ≤3% in the wavelengths between 280 nm and 365 nm and an ultraviolet transmittance of ≤6% in the wavelengths between 365 nm and 370 nm when the thermoplastic polyurethane resin composition is formed into a film having a thickness of 6 mils and wherein the cumulative weight % of UVA1 and UVA2 in the polyurethane resin composition ranges from 0.5 wt % to 0.85 wt % based on the total weight of the polyurethane resin composition.

2. The method according to claim 1, wherein the maximum ultraviolet transmittance is measured by the UV-VIS SPEC TEST.

3. The thermoplastic polyurethane resin according to claim 1, wherein the ultraviolet absorber package further comprises an oxanilide compound (UVA3).

4. The thermoplastic polyurethane resin according to claim 3, wherein the mass ratio of UVA1 to UVA2 to UVA3 is from 1:1:0.2 to 3:1:1.

5. The thermoplastic polyurethane resin composition according to claim 1, wherein the film has a maximum ultraviolet transmittance of ≤2% in the wavelengths between 280 nm and 365 nm and a maximum ultraviolet transmittance of ≤4% in the wavelengths between 365 nm and 370 nm.

6. The thermoplastic polyurethane resin composition according to claim 1, wherein the polyurethane resin comprises the reaction product of an isocyanate compound; a polyol compound; and a chain extender compound.

7. The thermoplastic polyurethane resin composition according to claim 1, wherein the film is applied onto a coated substrate.

8. The thermoplastic polyurethane resin composition according to claim 7, wherein the coated substrate is coated with one or more paint layers.

9. The thermoplastic polyurethane resin composition according to claim 10, wherein the one or more paint layers is a clear coat and the film is applied onto a surface of the clear coat.

10. A method for making a thermoplastic polyurethane resin, the method comprising:
reacting a mixture comprising an isocyanate compound, an isocyanate reactive compound, and a chain extender compound to form the thermoplastic polyurethane resin; wherein the mixture further comprises an antioxidant compound and an ultraviolet absorber package comprising a hindered amine light stabilizer compound, a benzotriazole compound (UVA1), and a traizine compound (UVA2) wherein the mass ratio of UVA1 to UVA2 is from 1:1 to 3:1; and
wherein the thermoplastic polyurethane resin composition has a maximum ultraviolet transmittance of ≤3% in the wavelengths between 280 nm and 365 nm and an ultraviolet transmittance of ≤6% in the wavelengths between 365 nm and 370 nm when the thermoplastic polyurethane resin is formed into a film having a thickness of 6 mils and wherein the cumulative weight % of UVA1 and UVA2 in the polyurethane resin composition ranges from 0.5 wt % to 0.85 wt % based on the total weight of the polyurethane resin composition.

11. The method according to claim 10, wherein herein the maximum ultraviolet transmittance is measured by the UV-VIS SPECT TEST.

12. The method according to claim 10, wherein the ultraviolet absorber package further comprises an oxanilide compound (UVA3).

13. The method according to claim 12, wherein the mass ratio of UVA1 to UVA2 to UVA3 is from 1:1:0.2 to 3:1:1.

14. The thermoplastic polyurethane resin composition according to claim 10, wherein the film has a maximum ultraviolet transmittance of ≤2% in the wavelengths between 280 nm and 365 nm and a maximum ultraviolet transmittance of ≤4% in the wavelengths between 365 nm and 370 nm.

15. The method according to claim 10, further comprising applying the thermoplastic polyurethane resin onto a coated substrate.

16. The method according to claim 15, wherein the coated substrate is coated with one or more paint layers.

17. The method according to claim 16, wherein the one or more paint layers is a clear coat and the film is applied onto a surface of the clear coat.
